(19) United States
(12) Patent Application Publication
(10) Pub. No.: US 2008/0170738 A1
(43) Pub. Date: Jul. 17, 2008

(54) ADJUSTABLE EARPHONES FOR PORTABLE DEVICES

(75) Inventors: Julian Hope, Bolton (GB); Peter Strong, Warrington (GB)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/676,949

(22) Filed: Feb. 20, 2007

Related U.S. Application Data
(60) Provisional application No. 60/885,079, filed on Jan. 16, 2007.

(51) Int. Cl. H04R 5/033

(52) U.S. Cl. 381/371; 381/374

(57) ABSTRACT

An earphone arrangement may be provided with at least one speaker arrangement including an earpiece adapted to be attached to the user's ear, and a speaker arranged in the earpiece so that the speaker faces the entrance of the ear canal of a user when the earpiece is operatively attached to the user's ear. The speaker arrangement may include an adjustment arrangement for adjusting the position of the speaker with respect to the earpiece, and thus the position of the speaker with respect to the entrance of the ear canal of the user when the earpiece is operatively attached to the user's ear.

### RELATED APPLICATION

This application claims priority under 35 U.S.C. § 119 based on U.S. Provisional Application Ser. No. 60/885,079, filed Jan. 16, 2007, the disclosure of which is incorporated herein by reference.

### TECHNICAL FIELD OF THE INVENTION

The present invention relates to the field of electronic devices and, more particularly, to communication devices and peripheral audio devices to be used therewith.

### DESCRIPTION OF RELATED ART

Within the field of portable devices, the trend is to make the devices as small as practicable, consistent with the trend to provide as much functionality as possible. One current trend is to provide portable devices with audio functions, such as radio receivers, media players, etc. However, the small size of modern portable devices makes it difficult to provide such devices with acceptable loudspeakers, considering the size of loudspeakers in general and the size of high-quality loudspeakers in particular. Likewise, the demand for portability makes it unsuitable to connect portable devices to large loudspeakers. In addition, in many circumstances, it is desirable to limit the audible output exclusively to the user of the device.

Portable devices are therefore usually provided with jacks for detachably connecting small, external personal headphones or the like to the device. External headphones will not affect the size of the portable device and the small size of the headphones will provide the required portability. It should be added that many headphones can be small and still produce high-quality sound.

Typical headsets comprise two small speakers where each speaker is adapted to be placed in close proximity to an ear of the user. The speakers receive an electrical signal from a media player or some other audio device and convert the received signal into audible sound waves that can be heard by the user. The configuration and operation of various headphones are well known to persons skilled in the art.

A speaker in a typical circumaural headphone is frequently surrounded by a pad or similar structure that extends around the ear of the user. Such headphones are often used in recording studios and among audiophiles. Supra-aural headphones, on the other hand, may utilize pads that are worn top of the user's ear. It follows that the pads of such headphones are arranged around or on top of the user's pinna (i.e. the visible part of the ear). In other words, the pads are neither arranged in the user's pinna nor in any part of the user's ear canal. Rather, the pads are arranged along the side of the user's head. The side of the head exhibits a substantially similar shape among most users. The sound wave from a speaker in such headphones will therefore enter the ear canal in substantially the same way for all users—even if the shape and size of the pinna and/or the ear canal differs between various users.

However, headphones using pads as described above are being rapidly replaced by even smaller, more inconspicous audio devices, such as earphones, earbuds, canalphones, and the like. This is particularly so in connection with portable devices. Earphones can be described as small headphones adapted to be fitted in the pinna directly outside the ear canal of the user. Some earphones may additionally be at least partly fitted in the opening of the ear canal or possibly even inside the ear canal. Earphones are generally inexpensive and are favored for their portability and convenience. However, due to their inability to provide isolation to ambient noise relative to circumaural and supra-aural headsets, earphones are typically not capable of delivering the precision and range of sound offered by many full-sized headphones. As a result, earphones are often used at higher volumes in order to “drown out” noise from the user's surroundings, which, among other things, increases the risk of hearing loss.

The problem of delivering a high-quality sound is emphasized by the fact that the sound from the speakers of the headphone may enter the ear canal in an undesirable angle with respect to the shape of the pinna and/or an ear canal. For example, the sound wave from the speaker or substantial parts thereof may be incident upon and reflect off of the sidewall of the ear canal and/or the side of the ear canal opening, which tends to deteriorate the sound quality or at least reduce the sound volume by the time it reaches the intended target, i.e., the eardrum.

In view of the above it would be advantageous to provide an earphone or other audio device that can be attached to the ear of substantially any user so as to provide a good attachment and a good isolation at the same time as the speaker or speakers of the earphone will be orientated to optimally direct sound waves so as to provide a better sound quality compared to other alternative orientations.

### SUMMARY OF THE INVENTION

Implementations of present invention are directed to providing an earphone or other audio device that can be attached to the ear of substantially any user so as to provide a good attachment and a good isolation at the same time as the speaker or speakers of the earphone or similar will be displaceably orientated so as to provide a better sound quality compared to other alternative orientations.

Implementations of the present invention provide an earphone or other audio device that includes speaker that may be moved independently of the earphone itself through manual manipulation by a user when the earphone is being worn.

According to a first aspect of the present invention directed to an earphone arrangement including at least one speaker arrangement comprising an earpiece adapted to be attached to the users ear, and a speaker arranged in the earpiece so that the speaker faces the entrance of the ear canal of a user when the earpiece is operatively attached to the user's ear, the earphone arrangement may be characterized in that the speaker arrangement comprises an adjustment arrangement for adjusting the position of the speaker with respect to the earpiece, and thus the position of the speaker with respect to the entrance of the ear canal of the user when the earpiece is operatively attached to the user's ear.

A second aspect of the invention is directed to an earphone arrangement that includes the features of the first aspect. The earphone arrangement may be characterized in that said adjustment arrangement comprises a speaker-housing comprising the speaker, which speaker-housing is movable arranged in the earpiece so that the position of the speaker can be adjusted with respect to the earpiece.

A third aspect of the invention is directed to an earphone arrangement that includes the features of the second aspect. The earphone arrangement may be characterized in that said speaker-housing is movably arranged in the earpiece so that speaker-housing can be rotated in substantially any direction with respect to the earpiece.

A fourth aspect of the invention is directed to an earphone arrangement that includes the features of the second or the third aspect. The earphone arrangement may be characterized in that said speaker-housing is movably arranged in the earpiece so that the user can move the speaker-housing by hand when the earpiece is operatively attached to the user's ear.

A fifth aspect of the invention is directed to an earphone arrangement that includes the features of the fourth aspect. The earphone arrangement may be characterized in that said movable speaker-housing protrudes from the earpiece so that the user can move the speaker-housing by hand when the earpiece is operatively attached to the user's ear.

A sixth aspect of the invention is directed to an earphone arrangement that includes the features of the fourth aspect. The earphone arrangement may be characterized in that said movable speaker-housing is substantially rigidly connected to a grip-part that protrudes from the earpiece so that the user can grip the protruding part and move the speaker-housing by hand when the earpiece (500) is operatively attached to the user's ear.

A seventh aspect of the invention is directed to an earphone arrangement that includes the features of the fourth aspect. The earphone arrangement may be characterized in that said movable speaker-housing is substantially movably coupled to a movable adjustment-part that protrudes from the earpiece so that the user can move the speaker-housing by moving the adjustment part by hand when the earpiece is operatively attached to the user's ear.

An eighth aspect of the invention is directed to an earphone arrangement that includes the features in any of the previous aspects. The earphone arrangement may be characterized in that it is an earphone.

A ninth aspect of the invention is directed to a portable device provided with an earphone arrangement according to any of the previous aspects.

A tenth aspect of the invention is directed to portable device that includes the features of the ninth aspect. The portable device may be characterized in that it is a phone or a music player.

According to an eleventh aspect of the present invention directed to a method for adjusting a earphone comprising at least one speaker arrangement comprising an earpiece adapted to be attached to the users ear, and a speaker arranged in the earpiece so that the speaker faces the entrance of the ear canal of a user when the earpiece is operatively attached to the user's ear, the method includes: attaching said earpiece to the user's ear; using an adjustment arrangement for adjusting the position of the speaker with respect to the earpiece; and thus the position of the speaker with respect to the entrance of the ear canal of the user.

A twelfth aspect of the invention is directed to a method that includes the features of the eleventh aspect. The method may be characterized by the steps of using an adjustment arrangement comprising a speaker-housing comprising the speaker, which speaker-housing is movable arranged in the earpiece, for adjusting the position of the speaker with respect to the earpiece.

A thirteenth aspect of the invention is directed to a method that includes the features of the twelfth aspect. The method may be characterized by the steps of using a movable speaker-housing that is arranged in the earpiece so that speaker-housing can be rotated in substantially any direction with respect to the earpiece.

A fourteenth aspect of the invention is directed to a method that includes the features of the twelfth or thirteenth aspect. The method may be characterized by the steps of using a movable speaker-housing that is arranged in the earpiece so that the user can move the speaker-housing by hand when the earpiece is operatively attached to the user's ear.

A fifteenth aspect of the invention is directed to a method that includes the features of the fourteenth aspect. The method may be characterized by the steps of using a movable speaker-housing that protrudes from the earpiece so that the user can move the speaker-housing by hand when the earpiece is operatively attached to the user's ear.

A sixteenth aspect of the invention is directed to a method that includes the features of the fourteenth aspect. The method may be characterized by the steps of using a movable speaker-housing that is substantially rigidly connected to a grip-part that protrudes from the earpiece so that the user can grip the protruding part and move the speaker-housing by hand when the earpiece is operatively attached to the user's ear.

A seventeenth aspect of the invention is directed to a method that includes the features of the fourteenth aspect. The method may be characterized by the steps of using a movable speaker-housing that is substantially movably coupled to a movable adjustment-part that protrudes from the earpiece so that the user can move the speaker-housing by moving the adjustment part by hand when the earpiece is operatively attached to the user's ear.

An eighteenth aspect of the invention is directed to a method that includes the features of the eleventh, twelfth, thirteenth or fourteenth aspect. The method may be characterized by the steps of using earphone arrangement in the form of an earphone.

Further advantages of the present invention and embodiments thereof will appear from the following detailed description of the invention.

It should be emphasized that the terms “comprises/comprising” and/or “includes/including” when used in this specification, are taken to specify the presence of stated features, integers, steps or components, but do not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 is a schematic view of an exemplary device in which systems and methods of the present invention may be implemented;

FIG. 2 is the device in FIG. 1 connected to an exemplary network;

FIG. 3 is a schematic block diagram of functional components of an exemplary device;

FIG. 4A is a perspective view an exemplary speaker arrangement according to an embodiment of the present invention;

FIG. 4B is a cross-section of the exemplary speaker arrangement in FIG. 4A cut along the section line II in FIG. 4A;

FIG. 4C is the exemplary speaker arrangement in FIG. 4B with the speaker tilted at an angle of α;

FIG. 4D is the exemplary speaker arrangement in FIG. 4B with the speaker tilted at an angle of −α;

FIG. 5A is a cross-section of another exemplifying speaker arrangement according to another implementation;

FIG. 5B is the speaker arrangement in FIG. 5A with the speaker tilted at an angle of α; and

FIG. 5C is the speaker arrangement in FIG. 5A with the speaker tilted at an angle of −α.

### DETAILED DESCRIPTION OF EMBODIMENTS

The present invention relates to portable devices in general, and to portable communication devices in particular, which devices may include an audio system for providing audio signals to a headphone arrangement. However, the invention is not limited to portable devices, such as mobile terminals that include an audio system. Rather, implementations of the invention may be applied to any suitable electronic device, such as a hearing aid or other type of aural device.

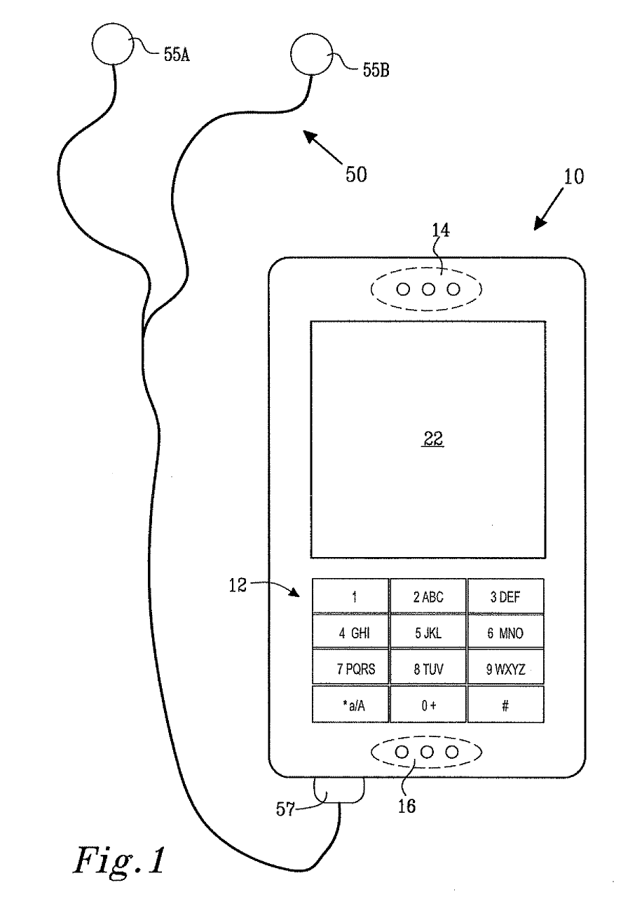

FIG. 1 shows a portable communication device according to one embodiment of the invention. The device may be a mobile cell, such as phone 10, which may be adapted to operate according to 3G-technology (e.g., W-CDMA or CDMA2000), 2.5-technology (e.g., GPRS), 2G-technology (e.g., GSM), or a similar technology. Information about 3G-technology, 2.5G-technology, or 2G-technology can be found in specifications from the 3^{rd} Generation Partnership Project (3GPP) (see, e.g., www.3gpp.org).

Phone 10 in FIG. 1 may include a keypad 12, a speaker 14, and a microphone 16. Keypad 12 may be used by a user of phone 10 to input information such as selection of functions and responding to prompts. Keypad 12 may be of any suitable kind, including but not limited to keypads with push-buttons, touch-buttons or another type of input mechanisms and/or a combination of different suitable input arrangements. Speaker 14 may include an audio device to present audible information to the user of phone 10. Microphone 16 may include a device for sensing the audio input from a user. In addition, phone 10 may include an antenna for communication with other communication devices via a network, as will be explained below. The antenna may be in-built in phone 10 and hence not shown in FIG. 1. Phone 10 in FIG. 1 may be provided with a display 22 for displaying images, video sequences, functions, prompts, and/or other visible information to a user of phone 10.

Phone 10, as shown in FIG. 1, is provided with an exemplifying and detachable earphone 50 that includes a first speaker arrangement 55A and a second speaker arrangement 55B (collectively, speaker arrangements 55). However, other embodiments of the present invention may use earphones or similar audio equipment having a single speaker arrangement. Earphone 50, as shown in FIG. 1, may attach to phone 10, for example, by an electric jack or plug 57. It should be emphasized that earphone 50 is schematically illustrated in FIG. 1, which implies that the real-life dimensions and shape of earphone 50, the speaker arrangements 55, and/or plug 57 may differ from that illustrated in FIG. 1. In some implementations, earphone 50 may wireless connect to phone 10, for example, using Bluetooth technology.

It will be appreciated that phone 10 in FIG. 1 is just one example of a portable communication device in which the invention may be implemented. Alternatively, the invention may be used, for instance, in connection with a music player, a radio, a PDA (personal digital assistant), a palm top computer, a lap top computer, a smartphone, or any other suitable mobile terminal or electronic device.

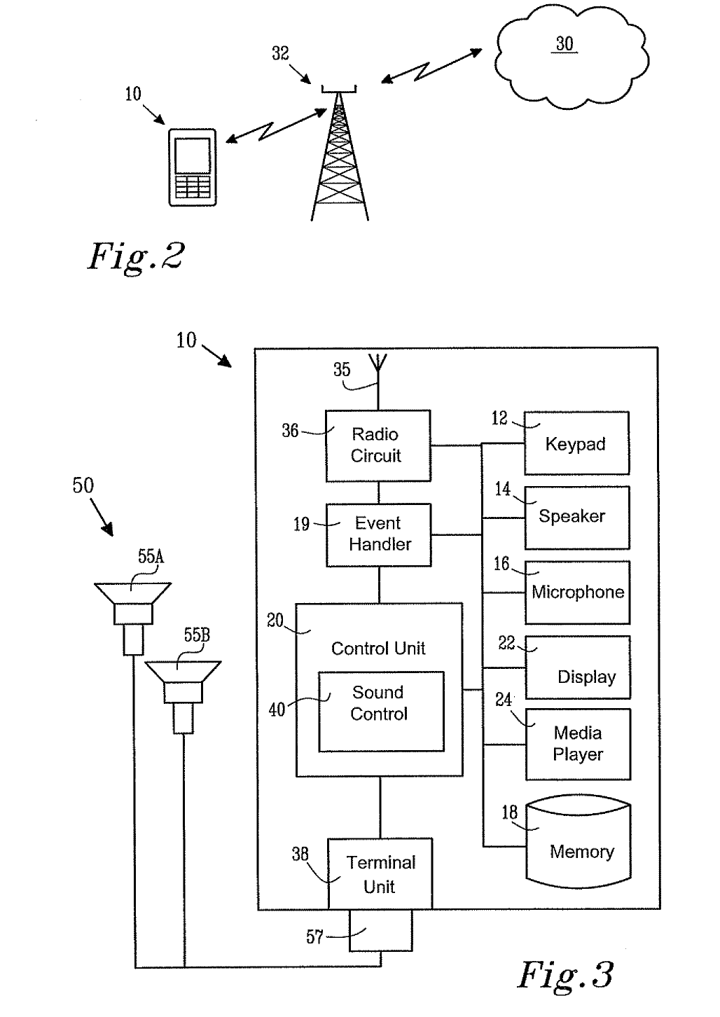

FIG. 2 shows phone 10 connected to a cellular network 30 via a base station 32. Network 30 may include a 3G network, such as a WCDMA network or similar network, but it may include a GPRS network or any other 2G, 2.5G, or 2.75G network. Moreover, network 30 does not have to be a cellular network, but may include some other type of network, such as the Internet, a corporate intranet, a LAN, a wireless LAN, PSTN, or other type of network.

FIG. 3 shows functional components that phone 10 may include. As previously explained, phone 10 may be provided with keypad 12, speaker 14, microphone 16, and/or display 22. Phone 10 may include a media player 24. Media player 24 may include an MP3 player, for example, being a part of phone 10t. Exemplifying phones that include media players, such as the W700i, the W710i, and the W850i models, are commercially available from Sony Ericsson. In addition, phone 10 may include a memory 18 for storing purposes in general, and in particular, for storing audio files to be used by media player 24. Memory 18 may include any suitable memory used in electronic devices.

Phone 10 may include an antenna 35 connected to a radio circuit 36 to enable radio communication with network 30, as described above with reference to FIG. 2. Radio circuit 36 may, in turn, connect to an event handling unit 19 for handling such events as outgoing and incoming communication to and from external units via network 30, for example, calls and messages, e.g., SMS (short message service), MMS (multimedia messaging service), and the like. In particular, streamed radio and similar audio services can be received from network 30, for example, using a connection to the Internet.

Phone 10 may include a terminal unit 38 for detachably connecting phone 10 to an external audio device, such as a headset. The headset may include an earphone, such as earphone 50 briefly described above with reference to FIG. 1. Terminal unit 38 may include a physical contact for attaching earphone 50. In addition, terminal unit 38 may include one or several drivers and/or transducers arranged to operatively provide an interface between the speaker arrangements 55 in earphone 50 and the sound functions of phone 10.

A control unit 20 may be arranged within phone 10 for controlling and supervising one or more operations of phone 10. Control unit 20 may be implemented, for example, using hardware and/or software and control unit 20 may include one or several hardware units and/or software modules, e.g., one or several processor units provided with or having access to the appropriate software and hardware required by the functions of phone 10. As can be seen in FIG. 3, control unit 20 may connect to keypad 12, speaker 14, microphone 16, memory 18, event handling unit 19, display 22, media player 24, and/or radio unit 36, for example, via a bus. Control unit 20 may control and communicate with other units of phone 10, for example, to exchange information and instructions with the units.

In some embodiments of the present invention, sound control 40 may include control unit 20. Being a part of control unit 20 implies that sound control 40 may be implemented, for example, using hardware and/or software and sound control 40 may include one or several hardware units and/or software modules, e.g., one or several processor units provided with or having access to the software and hardware appropriate for the functions required. Sound control 40 may be arranged to operatively process sound signals that are received and/or produced by phone 10. For example, sound control 40 may be configured to operatively forward sound signals in a suitable format to terminal unit 38 and/or speaker arrangements 55 in earphone 50 for producing audible sound to the user of earphone 50.

For example, media player 24 may play a music piece and sound control 40 may then forward suitable signals representing the music to terminal unit 38 so that speaker arrangements 55 of an attached earphone 50 may present an audible rendition to the user of earphone 50. Similarly, phone 10 may receive music from a streamed radio program or similar audio media via network 30, as substantially described above with reference to FIG. 2. Phone 10 may alternatively receive music from a broadcasted radio program or similar audio media that may be received by a radio receiver or similar device arranged in phone 10. Irrespective of the audio medium, sound control 40 may forward suitable signals representing the sound from the received sound signals to terminal unit 38 so that speaker arrangements 55 of an attached earphone 50 can reproduce an audible rendition to the user of earphone 50. Providing a suitable representation of various sound signals being received and/or produced by an electronic device so that speakers of a headset may render audio information to the user of headset or similar is well known and it needs not further description.

It should be appreciated that in addition to the parts and units shown in FIG. 3, further parts and units or similar devices may be present in phone 10. The parts and units shown in FIG. 3 may also be connected to more parts and units than that which is illustrated.

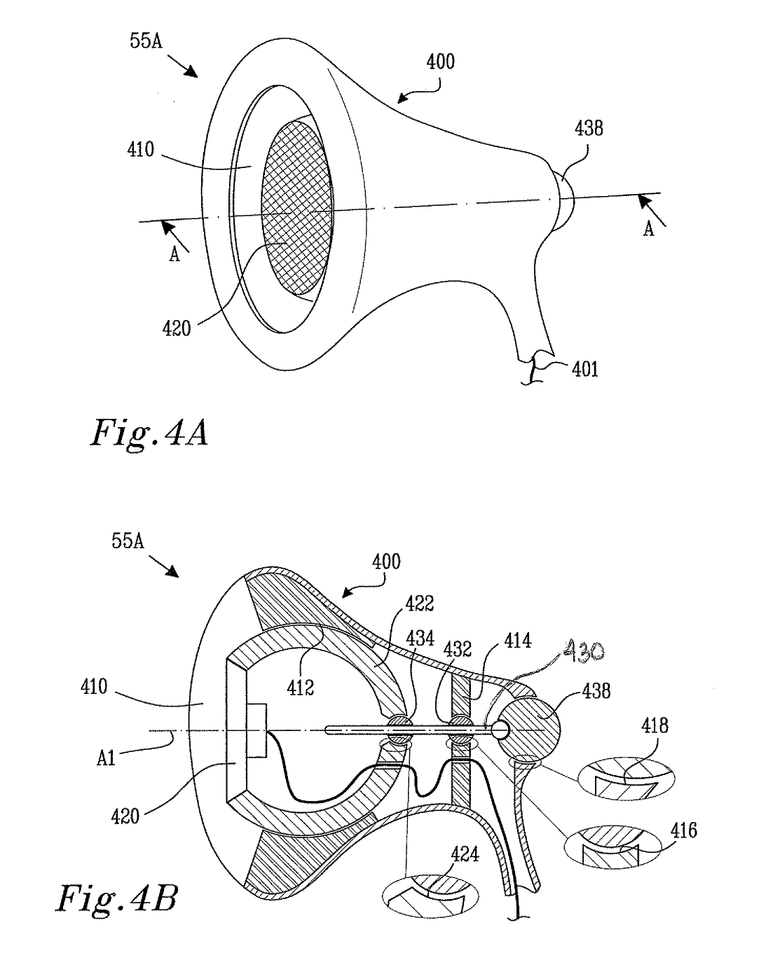

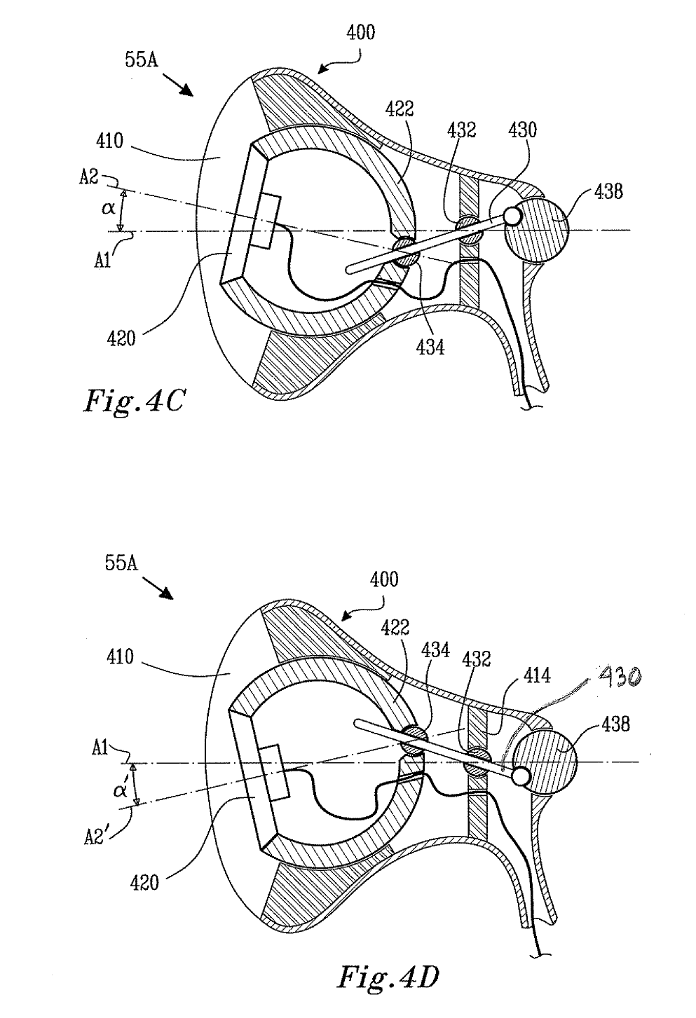

FIG. 4A shows a schematic illustration of an exemplifying speaker arrangement 55A, according to an embodiment of the present invention. According to some embodiments, speaker arrangements 55A, 55B, discussed above with reference to FIGS. 1 and 3, may be substantially identical, possibly with exception for adaptations to account for differences between the human right and left ears. However, for the sake of simplicity the description below will refer to speaker arrangement 55A. Nevertheless, the description of speaker arrangement 55A is applicable mutatis mutandis to speaker arrangement 55B.

As can be seen in FIG. 4A, speaker arrangement 55A may include an earpiece 400 adapted to be fitted in the pinna (i.e., in the visible part of the ear) outside the user's ear canal. In addition, earpiece 400 may be at least partly fitted in the opening of the ear canal or possibly even inside the ear canal (e.g., canalphones).

Exemplifying earpiece 400 in FIG. 4A has an aperture, such as opening 410, for example, that is substantially circular and arranged in a front-end of earpiece 400 so as to face the entrance of the user's ear canal when earpiece 400 is attached to the user's ear. Speaker 420 may be arranged in and/or behind the opening 410 so as to face the entrance of the user's ear canal when earpiece 400 is attached to the user's ear. Hence, the sound waves produced by speaker 420 will substantially propagate in a direction towards the user's eardrum when earpiece 400 is attached to the user's ear. In one implementation, speaker 420 may be arranged so that the sound waves propagate through the ear canal in a direction that is substantially perpendicular to the user's eardrum when earpiece 400 is attached to the user's ear. Speaker 420 may be any suitable speaker arrangement, e.g., any suitable speaker arrangement that is currently used in existing earphones.

FIG. 4B is a cross-section cut at the center axis of speaker arrangement 55A in FIG. 4A and viewed along two arrows A and A in FIG. 4A. The cross-section reveals the interior of earpiece 400. It can be seen that a speaker housing 422 that is substantially spherical is arranged inside earpiece 400 with an outer part protruding into opening 410 at a front-end of earpiece 400. An adjustment ball 438 that is substantially spherical is arranged at the back-end of earpiece 400 for adjusting the position of speaker housing 422 by means of a moving arrangement, as will be described in more detail below. It should be appreciated that speaker 420 may be provided suitable audio signals, for example, via a supply cord 401, as schematically illustrated in FIG. 4B.

Speaker 420 may be substantially fixedly arranged in the outer part of speaker housing 422 protruding into opening 410 of earpiece 400. Speaker housing 422 may be rotatably fitted in a housing holder 412 that may be formed as a part of a substantially spherical cavity inside earpiece 400. In one implementation, speaker housing 422 and housing holder 412 may form parts of two spheres, one being rotatably fitted into the other, it follows that speaker housing 422 and speaker 420 may be rotated in substantially any direction inside housing holder 412. Spherical adjustment-ball 438 may be movably fitted in a ball holder 418 formed in the back-end of earpiece 400 opposing opening 410 formed in the front-end of the earpiece 400. Ball holder 418 may form part of a substantially spherical cavity. Hence, it follows that adjustment ball 438 may be rotated in substantially any direction inside ball holder 418. An outer part of adjustment ball 438 may protrude out from the back-end of earpiece 400 so that a user may move adjustment ball 438 by hand. In one implementation, adjustment ball 438 may be arranged in earpiece 400 so that a user can move adjustment ball 438 when earpiece 400 is worn by the user. The tolerance between speaker housing 422 and housing holder 412 may be configured such that speaker housing 422 may be fixed at a given position within housing holder 412 by friction until overcome by manual force applied to adjustment ball 438.

In addition, a rod 430 may be attached to the inner side of adjustment ball 438 using, for example, a ball-and-socket joint. The “ball-unit” of the joint may be arranged on rod 430 and the “socket-unit” of the joint may be arranged on or near an inner peripheral part of adjustment ball 438 at the opposite side of the protruding outer part of adjustment ball 438. Rod 430 may extend from adjustment ball 438 into speaker housing 422.

For example, rod 430 may extend in a sliding manner from adjustment ball 438 into speaker housing 422 through the center of a first pivot ball 432 that is substantially spherical and through the center of a second pivot ball 434 that is substantially spherical. First pivot ball 432 may be arranged spatially fixed at a distance from adjustment ball 438. For example, first pivot ball 432 may be rotatably fitted in a first pivot-holder 416 formed as a part of a substantially spherical cavity in a wall 414 inside earpiece 400. Hence, first pivot ball 432 may be rotated in substantially any direction inside first pivot holder 416. Second pivot ball 434 may be arranged in a spatially movable manner at a distance from first pivot ball 432. For example, second pivot ball 434 may be rotatably fitted in a second pivot holder 424 that is formed as a part of a substantially spherical cavity in the wall of speaker housing 422 at the opposite side of speaker 420. Hence, second pivot ball 434 may be rotated in substantially any direction inside second pivot holder 424.

In a “neutral” adjustment position shown in FIG. 4B, in one implementation the center of adjustment ball 438, the center of the “ball-unit” in the ball-and-socket joint, the center of first pivot ball 432, the center of second pivot ball 424 and the center of speaker housing 422 are all positioned on or near a center-axis A1 of earpiece 400 extending through rod 430 as positioned in FIG. 4B. However, in other adjustment positions, the center of the “ball-unit” and the center of second pivot ball 424 may not be positioned on or near axis A1, whereas the center of adjustment ball 438, the center of first pivot ball 432, and the center of speaker housing 422 may remain positioned on or near center axis A1 of earpiece 400.

The above description of an exemplifying adjustment arrangement—including adjustment ball 348, ball holder 418, sliding rod 430, first pivot ball 434, first pivot holder 416, second pivot ball 434, second pivot holder 424, and speaker housing 422, as shown in FIG. 4B—makes it clear to an observant reader that speaker 420 may be positioned with respect to earpiece 400 in substantially any direction by rotation of adjustment ball 438 by a user.

It should be particularly clear that a user of speaker arrangement 55A may rotate adjustment ball 438 in substantially any direction to change the position of rod 430, which causes first pivot ball 432 to rotate in a spatially fixed position while rod 430 slides through the center of first pivot ball 432. In turn, this causes second pivot ball 434 to rotate in a spatially movable manner while rod 430 slides through the center of second pivot ball 434. Since second pivot ball 434 may be rotatably fitted in second pivot holder 424 formed in the wall of speaker-housing 422, it follows that speaker-housing 422 and speaker 420 may be rotated in the same or similar manner as adjustment ball 438. Hence, since adjustment ball 438 may be rotated in substantially any direction, it follows that speaker housing 422 and speaker 420 may be adjusted to in various directions.

FIG. 4C shows speaker arrangement 55A with speaker housing 422 and speaker 420 rotated an angle α with respect to center axis A1 of earpiece 400. This causes sound waves from speaker 420 to propagate in a direction substantially along axis A2, being substantially normal to a face of speaker 420, as indicated in FIG. 4C.

FIG. 4D shows speaker arrangement 55A with speaker housing 422 and speaker 420 rotated an angle −α with respect to center axis A1 of earpiece 400. This causes sound waves from speaker 420 to propagate in a direction substantially along the axis A2′ being substantially normal to a face of speaker 420, as indicated in FIG. 4D.

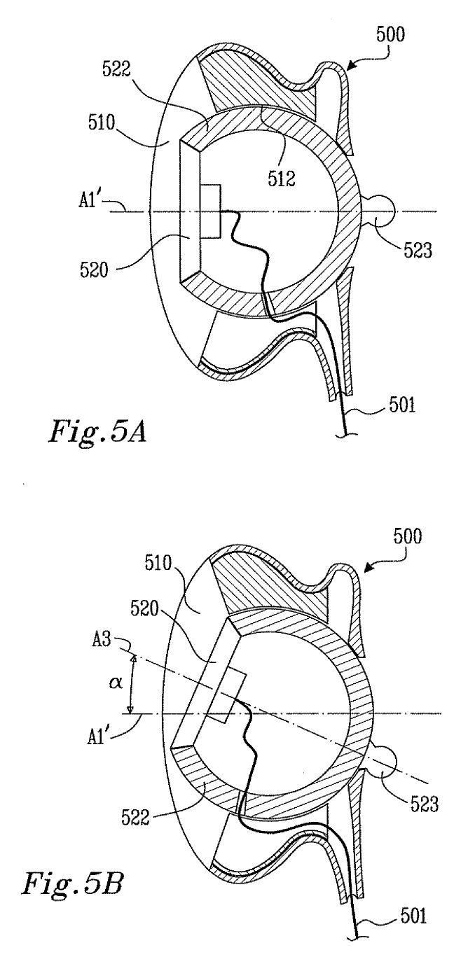

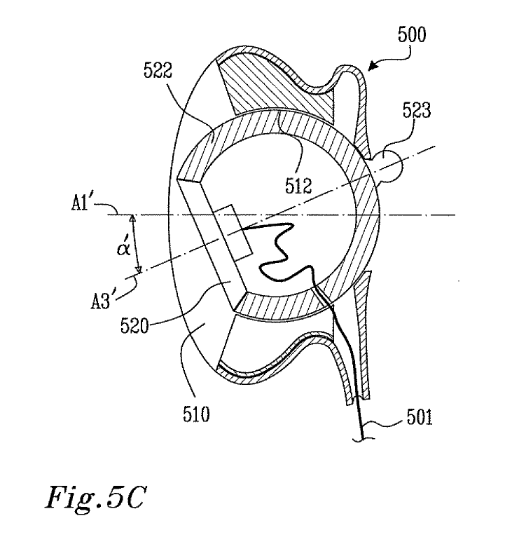

FIG. 5A is a cross-section of another exemplifying speaker arrangement comprising an earbud, such as earpiece 500 adapted to be fitted in the pinna (i.e., in the visible part of the ear) outside the user's ear canal in a manner that is substantially similar to speaker arrangement 55A shown in FIG. 4A.

Earpiece 500 in FIG. 5A may have an opening 510 that is substantially circular arranged in the front-end of earpiece 500 so as to face the entrance of the user's ear canal when earpiece 400 fitted to the user's ear. Likewise, a speaker 520 is arranged in and/or behind opening 510 so as to face the entrance of the user's ear canal when earpiece 500 is inserted into the user's ear. Hence, the sound waves produced by speaker 520 may propagate in a direction towards the user's eardrum when earpiece 500 worn by the user. For example, in one implementation, speaker 520 may be arranged so that sound waves propagate through the ear canal in a direction that is substantially perpendicular to the user's eardrum when earpiece 400 is attached to the user's ear. It should be appreciated that speaker 520 may be provided with suitable audio signals, for example, via a supply cord 501, as schematically illustrated in FIG. 5A, substantially similar to that described above with respect to speaker arrangement 55A shown in FIG. 4A.

As can be seen in FIG. 5A, speaker 520 may be arranged in a speaker housing 522 that is substantially spherical. Speaker housing 522 may be rotatably fitted in a housing holder 512 formed as a part of a substantially spherical cavity inside earpiece 500. Hence, speaker housing 522 and speaker 520 may be rotated in substantially any direction inside housing holder 512. An outer part of speaker housing 522 may protrude from the back-end of earpiece 500 so that a user may manually move speaker housing 522. In one implementation, speaker housing 522 may be arranged in earpiece 500 so that a user can move speaker housing 522 when earpiece 500 is attached to the user's ear. A knob 523 may be arranged in the center of the protruding part of speaker housing 522 to facilitate the movement of speaker housing 522. However, where speaker housing 522 is arranged inside earpiece 500 without any parts protruding outside earpiece 500, knob 523 may at least protrude from the back-end of earpiece 500. However, this may require a projection that is larger than knob 523 as shown in FIG. 5A, so that the projection can extend from the speaker-housing 522 to the outside of the earpiece 500.

In a “neutral” adjustment position shown in FIG. 5A, in one implementation speaker housing 522 and speaker 520 may be positioned on or near a center-axis A1′ of earpiece 500.

The above description of a second exemplifying adjustment arrangement—including speaker housing 522 possibly provided with knob 523—makes it clear to an observant reader that a user of speaker arrangement in FIG. 5A can rotate the speaker 520 in substantially any direction with respect to the earpiece 500 by rotating the speaker-housing 522.

FIG. 5B shows the speaker arrangement in FIG. 5A with speaker housing 522 and speaker 520 rotated an angle α with respect to center axis A1′ of earpiece 500. This causes sound waves from speaker 520 to propagate in a direction substantially along axis A3 being substantially normal to a face of speaker 520, as indicated in FIG. 5B.

FIG. 5C shows the speaker arrangement in FIG. 5A with speaker housing 522 and speaker 520 rotated an angle −α with respect to center axis A1′ of earpiece 500. This causes sound waves from speaker 520 to propagate in a direction substantially along axis A3′ being substantially normal to a face of speaker 520, as indicated in FIG. 5C.

In view of the above, it should be clear that the present invention provides an earphone 50 with speaker arrangements 55 that may be attached to the ears of substantially any user so as to provide an optimized attachment and isolation, at the same time as speakers 420, 520 of speaker arrangements 55 can be positioned so as to provide an optimized sound quality compared to other alternative positions. In other words, the attachment and isolation of speaker arrangements 55 may be optimized substantially independent from an optimization of the orientation of speakers 420, 520 in speaker arrangements 55 of earphone 50.

In some implementations, speakers 420, 520 may be substantially freely movable among a range of possible positions. In alternative implementations, speakers 420, 520 may be substantially discretely movable among predetermined settings, for example, at predetermined angles (e.g., 5, 10, 15, 25, 30, 35, 40, or 45 degrees, etc.) offset from center axes A1, A1′. In other words, a user may toggle from a first position to a second position, from the second position to a third position, from a third position to a fourth position, and so on. For example, co-acting teeth may be formed on one or more surfaces of one or more of the above-described components of speaker arrangements 55, for example, to produce a ratchet-like effect. Other structural formations may be used to delimit incremental relative movement of speakers 420, 520 in speaker arrangements 55.

In some implementations, the orientation of speakers 420, 520 may be indicated to the user, for example, audibly and/or visually. For example, speaker arrangements 55 may include sensors and/or a signal generating device that transmits positioning information associated with speakers 420, 520 to, for example, control unit 20. Control unit 20 may process the positioning information and send the information to display 22, for example, for graphic representation of the positioning of speakers 420, 520.

The present invention has now been described with reference to exemplifying embodiments. However, the invention is not limited to the embodiments described herein. On the contrary, the full extent of the invention is only determined by the scope of the appended claims.

What is claimed is:

1. An earphone comprising:
at least one speaker arrangement including:
an earpiece, and
a speaker arranged in the earpiece to face an entrance of an ear canal of a user, and
an adjustment arrangement to adjust a position of the speaker relative to the earpiece, wherein the earpiece substantially maintains a position with respect to the ear canal of the user during the adjusting.

2. The earphone arrangement according to claim 1, the adjustment arrangement comprising a speaker housing associated with the speaker, wherein the speaker housing is displaceably arranged in the earpiece so that the position of the speaker can be adjusted with respect to the earpiece.

3. The earphone according to claim 2, wherein said speaker housing is movably arranged in the earpiece so that speaker housing can be rotated in substantially any direction with respect to the earpiece.

4. The earphone according to claim 2, wherein the speaker housing is movably arranged in the earpiece so as to be manually displaceable when the earpiece is operatively worn by the user.

5. The earphone according to claim 4, wherein a portion of the speaker housing protrudes from the earpiece when the earpiece is operatively worn by the user.

6. The earphone according to claim 4, wherein the movable speaker housing is substantially rigidly connected to a grip-able part that protrudes from the earpiece so that the user can grip the protruding part and move the speaker housing by hand when the earpiece is operatively attached to the user's ear.

7. The earphone according to claim 4, wherein the movable speaker housing is substantially movably coupled to a movable adjustment part that protrudes from the earpiece so that the user can move the speaker housing by moving the adjustment part by hand when the earpiece is operatively attached to the user's ear.

8. The earphone according to claim 1, wherein the adjustment arrangement is configured to adjust the position of the speaker relative to the earpiece to one of a number of discrete positions.

9. A portable device comprising:
at least one speaker arrangement including:
an earpiece, and
a speaker arranged in the earpiece to face an entrance of an ear canal of a user, and
an adjustment arrangement to adjust a position of the speaker relative to the earpiece, wherein the earpiece substantially maintains a position with respect to the ear canal of the user during the adjusting.

10. The portable device according to claim 9, wherein the portable device comprises a phone or a music player.

11. In an earphone including at least one speaker arrangement that includes an earpiece and a speaker arranged in the earpiece so that the speaker faces the entrance of the ear canal of a user when the earpiece is operatively attached to an ear of a user, a method of positioning the speaker relative to the earphone, comprising:
fitting the earpiece to the ear; and
using an adjustment arrangement for adjusting the position of the speaker with respect to the earpiece while substantially maintaining a position of the earpiece relative to the ear.

12. The method according to claim 11, wherein the adjustment arrangement comprises a speaker housing including the speaker, wherein the speaker housing is displaceably arranged in the earpiece, for adjusting the position of the speaker with respect to the earpiece.

13. The method according to claim 12, wherein the speaker housing is rotatable in substantially any direction with respect to the earpiece.

14. The method according to claim 12, wherein the speaker housing is configured to be manually displaced when the earpiece is operatively attached to the user's ear.

15. The method according to claim 14, wherein at least a portion of the speaker housing protrudes from the earpiece when the earpiece is operatively attached to the user's ear.

16. The method according to claim 14, wherein the speaker housing is substantially rigidly connected to a grip-able part that protrudes from the earpiece so that the user can grip the protruding part and move the speaker housing by hand when the earpiece is operatively attached to the user's ear.

17. The method according to claim 14, wherein the speaker housing is substantially movably coupled to a movable adjustment part that protrudes from the earpiece so that the user can move the speaker housing by moving the adjustment part by hand when the earpiece is operatively attached to the user's ear.
